(19) United States
(12) Patent Application Publication
(10) Pub. No.: US 2012/0107686 A1
(43) Pub. Date: May 3, 2012

(54) CATHODE MATERIAL FOR LITHIUM SECONDARY BATTERIES AND LITHIUM SECONDARY BATTERY CONTAINING THE SAME

(75) Inventors: Kwang -Sun Ryu, Ulsan (KR); Suk-Joon Park, Chungcheongbuk-do (KR); Jik-Soo Kim, Chungcheongbuk-do (KR); Kyung Shin, Chungcheongbuk-do (KR); Young-Min Chung, Ulsan (KR); Joeng-Hun Ju, Ulsan (KR); Yu-Rim Bak, Ulsan (KR)

(73) Assignee: ECOPRO CO., LTD, Chungbuk (KR)

(21) Appl. No.: 13/255,577

(22) PCT Filed: Mar. 11, 2010
(86) PCT No.: PCT/KR2010/001532

§ 371 Date: Oct. 26, 2011

(30) Foreign Application Priority Data
Mar. 11, 2009 (KR) 10-2009-0020730

(51) Int. Cl. H01M 4/62; H01M 4/131

(52) U.S. Cl. 429/215; 429/220; 429/221; 429/223; 429/224; 429/231.5; 429/231.6; 429/231.95

(57) ABSTRACT

This invention relates to a positive electrode active material for a lithium secondary battery and a lithium secondary battery including the same, and particularly to a positive electrode active material for a lithium secondary battery, in which a lithium composite oxide having a composition of LiNi₁₋ₓMₓO₂ (wherein M represents one or a combination of two elements selected from the group consisting of Co, Al, Mn, Mg, Fe, Cu, Ti, Sn and Cr, and 0.96≦x≦1.05) is surface-modified using carbon or an organic compound, thereby achieving superior stability and improved high-rate capability compared to conventional positive electrode active materials, and to a lithium secondary battery including the same.

### TECHNICAL FIELD

The present invention relates to a positive electrode active material for a lithium secondary battery and a lithium secondary battery comprising the same, and, more particularly, to a positive electrode active material for a lithium secondary battery in which a lithium composite oxide having a composition of LiNi₁₋ₓMₓO₂ (wherein M represents any one or a combination of two elements selected from the group consisting of Co, Al, Mn, Mg, Fe, Cu, Ti, Sn and Cr, and 0.96≦x≦1.05) is surface-modified using carbon or an organic compound, and to a lithium secondary battery comprising the same.

### BACKGROUND ART

A lithium secondary battery is an energy storage device which comprises a positive electrode material that emits lithium during charging, a negative electrode material that receives lithium during charging, an electrolyte that is a lithium ion transfer medium, a separator that separates the positive electrode and the negative electrode from each other, and other parts.

Such a lithium secondary battery, which has high energy density and driving voltage, is recently being used in information electronic devices including mobile phones, etc. as a main energy source for transmitting not only sounds but also images, and is also expected to be variously applied across industries including the automobile industry hereafter.

With the recent drastic development of information communication devices, the market for lithium secondary batteries is rapidly increasing.

Continuous advancements have been made in lithium secondary batteries by developing parts and materials as well as the structure of the battery since it was first commercially produced by Sony in 1991, and thus the performance thereof is rapidly increasing by 10% or more per year and the lithium secondary battery is becoming essential to modern life. Among the components of the lithium secondary battery, a positive electrode material has a great influence on a variety of properties of the lithium secondary battery, including the driving voltage, performance, etc. Thus, various attempts have been made to develop a novel positive electrode material to be used in the field of lithium secondary batteries. Below is a brief description of such a positive electrode material.

An example of the positive electrode active material for a lithium secondary battery which has been very easily available up until now is lithium cobalt oxide (LiCoO₂). Since Sony Energytech gave birth to a lithium secondary battery in 1991, manufacturing it by combining hard carbon for the negative electrode, a carbonate-based organic solvent and a lithium salt as an electrolyte, and lithium cobalt oxide as the positive electrode, lithium cobalt oxide has been widely utilized as the positive electrode material up to the present. This is because a variety of properties required of a secondary battery, for example, high voltage, high capacity, high-rate capability, cycle performance, charge/discharge reversibility, voltage plateau, etc. are met by the above material. However, cobalt metal which is a main element of lithium cobalt oxide is problematic in terms of profitability due to its higher cost, the limitation of resources depending on the reserves, and environmental restrictions attributable to environmental contamination, compared to other transition metals. Also, cobalt has a theoretical capacity of 274 mAh/g, but the actual capacity thereof is 150 mAh/g (because of the deintercalation of lithium caused by structurally irreversible phase transfer). Hence, thorough research into positive electrode active materials that can be used to replace lithium cobalt oxide is ongoing.

Examples of a positive electrode active material usable instead of lithium cobalt oxide include LiMn₂O₄ (a spinel structure), LiFePO₄ (an olivine structure), LiNiO₂ (a layer structure like LiCoO₂), etc. Among these, lithium manganese oxide (LiMnO₄) is a 4V material having a spinel structure. This has a very small capacity to the extent of a theoretical capacity of 148 mAh/g and an actual capacity of 120 mAh/g, but has very superior safety and is inexpensive and thus profitable (at least four times more so upon mass production) compared to lithium cobalt oxide, and thus it continues to be researched. The technical problems of such lithium manganese oxide to be overcome include improvements in terms of cycle performance and high-temperature storage properties, in addition to the increase in the capacity thereof. The causes of the low cycle performance and poor high-temperature storage properties are known to be Jahn Teller distortion and Mn dissolution. In order that low cost and stability which are the strengths of the manganese-based spinel material of lithium manganese oxide are brought to the fore and the low capacity which is a drawback of lithium manganese oxide is increased, a lithium manganese/nickel oxide material in which manganese and nickel are subjected to solid solution treatment is provided. However, in the case of lithium manganese/nickel oxide, techniques that generate uniform quality upon mass production should be developed, and problems including a limitation of packing of an active material and the introduction of impurities upon synthesis which deteriorate the properties of the battery should be overcome. On the other hand, lithium iron phosphorus oxide (LiFePO₄), which is a typical example of a lithium transition metal phosphorus oxide, is profitable thanks to its low cost and has high safety thanks to an olivine structure, in particular high-temperature stability. Furthermore, lithium iron phosphorus oxide has a theoretical capacity of 170 mAh/g, and may have 150˜160 mAh/g that is close to the theoretical capacity depending on the synthesis conditions, and also is very superior in terms of the voltage plateau in the range of 3.2-3.4 V, and thus there is a very high probability that it will substitute for lithium cobalt oxide. However, lithium iron phosphorus oxide is disadvantageous because of its low voltage and the low electrical conductivity of the active material itself, undesirably decreasing the high-rate capability. To overcome such problems, adding a large amount of conductive material upon synthesis or increasing the amount of conductive material upon formation of an electrode may be performed, which may undesirably result in decreasing the volume energy density.

Compared to the above positive electrode active materials, LiNiO₂ has a layer structure like lithium cobalt oxide, and has an actual capacity corresponding to 70% (about 190 mAh/g) of the theoretical capacity thereof, which is higher than the 140 mAh/g that is the actual capacity of lithium cobalt oxide. However, because nickel is easily reduced to bivalence compared to cobalt (Ni prefers bivalence to trivalence), a shortage of lithium easily occurs upon synthesis because of the volatilization of a lithium salt which is the source of lithium, and such an empty space (3b) is occupied by bivalent nickel, thus easily forming a non-stoichiometric structure. Such a structure hinders the diffusion of lithium upon charging/discharging, thus deteriorating the charge/discharge properties. Despite such problems, however, Ni has high energy density, and thus is favorable in terms of increasing the capacity, and it continues to be researched. To exhibit such advantages, there are reports in which electrochemical properties are improved using surface modification, thereby stabilizing the surface structure, so that activation energy for phase transfer reactions and structural destruction occurring from the surface may be increased and thus the reaction itself is delayed. For example, Korean Patent Laid-open Publication No. 2006-0084886 discloses a positive electrode active material coated with a conductive polymer, which has a superior cycle life upon high-temperature storage. Also, there are many reports to the effect that doping with different metals (Co, Al, Sn, Ti, etc.) is done instead of performing such surface modification so as to increase the stability of a lattice structure, thereby improving electrochemical properties. For example, Korean Patent Laid-open Publication No. 2000-0074691 discloses a method of adding La or Ce to a nickel-based positive electrode active material in which part of Ni of LiNiO₂ is substituted into Co, thus decreasing the irreversible capacity to increase a capacity and improving cycle performance.

In particular, Liₓ[Ni_{1-y-z}CO_{y}Al_{z}]O₂ (wherein 0.96≦x≦1.05, 0≦y≦0.2, 0≦z≦0.1, hereinafter referred to as “LNCA”) is a positive electrode material having high thermal stability, a long cycle life, high discharge voltage because of the Co, and improved stability of the layer structure because of the Al (Journal of Power Sources, 136 (2004)132-138). However, this material is still weak in moisture, and H₂O present in the electrolyte reacts with LiPF₆ to form a strong acid, HF, after which such HF attacks the transition metal present in the positive electrode active material, so that the transition metal dissolves in the electrolyte thus breaking the active material, resulting in shortening the life of the battery. Furthermore, upon charging/discharging, structural instability in which a monoclinic structure is converted into a hexagonal structure may occur, undesirably decreasing the capacity.

Culminating in the present invention, intensive and thorough research was carried out by the present inventors aiming to solve, the problems encountered in the related art, resulted in the finding that the surface of LNCA may be modified with carbon or an organic compound, thus imparting high conductivity to the positive electrode active material so that electrons may freely flow, and also carbon functions as a mechanically or (electro) chemically protective shell (suppression of the production of impurities, protection against acids, and formation of a structural framework during continuous charging/discharging or rapid charging/discharging), thus improving the stability of a lithium secondary battery and its high-rate capability.

### DISCLOSURE

### Technical Problem

Accordingly, the present invention has been made keeping in mind the above problems occurring in the related art, and an object of the present invention is to provide a positive electrode active material for a lithium secondary battery, which has improved conductivity so that electrons may freely flow, and also has higher stability, compared to conventional positive electrode active materials.

Another object of the present invention is to provide a lithium secondary battery which comprises the above positive electrode active material and thus the stability may be much higher and the high-rate capability may be improved.

### Technical Solution

In order to accomplish the above objects, the present invention provides a positive electrode active material for a lithium secondary battery, comprising a lithium composite oxide represented by Chemical Formula 1 below which is surface-modified using carbon or an organic compound.

LiNi₁₋ₓMₓO₂ <Chemical Formula 1>

(wherein M represents any one or a combination of two elements selected from the group consisting of Co, Al, Mn, Mg, Fe, Cu, Ti, Sn and Cr, and 0.96≦x≦1.05).

In particular, the lithium composite oxide represented by Chemical Formula 1 may be a lithium composite oxide represented by Chemical Formula 2 below.

Liₓ[Ni_{1-y-z}CO_{y}Al_{z}]O₂ <Chemical Formula 2>

(wherein 0.96≦x≦1.05, 0≦y≦0.2, 0≦z≦0.1)

In addition, the present invention provides a lithium secondary battery comprising the above positive electrode active material.

### Advantageous Effects

According to the present invention, a positive electrode active material for a lithium secondary battery can be improved in terms of conductivity so that electrons can freely flow, and also can have increased stability, compared to conventional positive electrode active materials. In a lithium secondary battery comprising the positive electrode active material, carbon functions as a mechanically or (electro)chemically protective shell, thus exhibiting high stability including suppression of the production of impurities, protection against acids, and formation of a structural framework during continuous charging/discharging or rapid charging/discharging, and simultaneously exhibiting high-rate capability.

### DESCRIPTION OF DRAWINGS

FIG. 1 is of a scanning electron microscope (SEM) image showing a positive electrode active material (Example 1) surface-modified with carbon according to an embodiment of the present invention, and a graph showing the discharge capacity in relation to the current density of a lithium secondary battery manufactured using the same;

FIG. 2 is an SEM image showing a positive electrode active material which is not surface-modified; and

FIG. 3 is of an SEM image showing a positive electrode active material (Example 2) surface-modified with carbon according to an embodiment of the present invention, and a graph showing the discharge capacity in relation to the current density of a lithium secondary battery manufactured using the same;

FIG. 4 is a transmission electron microscope (TEM) image showing the positive electrode active material (Example 2) surface-modified with carbon according to the embodiment of the present invention;

FIG. 5 is of an SEM image showing a positive electrode active material (Example 3) surface-modified with carbon according to an embodiment of the present invention, and a graph showing the discharge capacity in relation to the current density of a lithium secondary battery manufactured using the same;

FIG. 6 is of an SEM image showing a positive electrode active material (Example 4) surface-modified with carbon according to an embodiment of the present invention, and a graph showing the discharge capacity in relation to the current density of a lithium secondary battery manufactured using the same;

FIG. 7 is a TEM image showing the positive electrode active material (Example 4) surface-modified with carbon according to the embodiment of the present invention; and

FIG. 8 is of an SEM image showing a positive electrode active material (Example 5) surface-modified with polyaniline according to an embodiment of the present invention, and a graph showing the discharge capacity in relation to the current density of a lithium secondary battery manufactured using the same.

### MODE FOR INVENTION

Hereinafter, a detailed description will be given of the present invention.

According to the present invention, a positive electrode active material for a lithium secondary battery comprises a lithium composite oxide which is surface-modified using carbon or an organic compound.

In the present invention, the lithium composite oxide may include a lithium composite oxide represented by Chemical Formula 1 below.

LiNi₁₋ₓMₓO₂ <Chemical Formula 1>

(wherein M represents one or a combination of two elements selected from the group consisting of Co, Al, Mn, Mg, Fe, Cu, Ti, Sn and Cr, and 0.96≦x≦1.05)

Particularly useful as the lithium composite oxide represented by Chemical Formula 1 is a lithium composite oxide represented by Chemical Formula 2 below.

[Ni_{1-y-z}CO_{y}Al_{z}]O₂ <Chemical Formula 2>

(wherein 0.96≦x≦1.05, 0≦y≦0.2, 0≦z≦0.1)

Used in the present invention, the carbon or organic compound which is a non-metal unlike the positive electrode active material for a lithium secondary battery is not particularly limited so long as it may improve the stability and the high-rate capability while not greatly affecting battery performance. Specifically, the carbon or organic compound may include carbon, solid alcohol, saccharides such as sucrose, citric acid, a conductive polymer, etc. Furthermore, the conductive polymer may include polythiophene represented by Chemical Formula 3 below, polypyrrole represented by Chemical Formula 4 below, polyaniline represented by Chemical Formula 5 below, and derivative monomers thereof, which may be used alone or in mixtures of two or more.

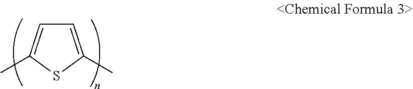

(wherein n is an integer of 120˜6,000)

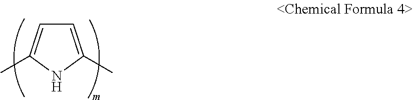

(wherein m is an integer of 150˜7,700)

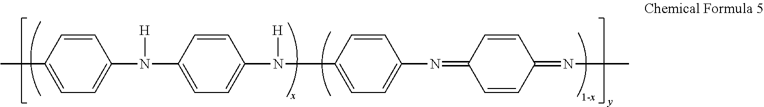

(wherein x is a decimal in the range of 0<x<1, and y is an integer of 25˜1,400)

The amount of the carbon or organic compound may be appropriately adjusted in order to improve physical properties of the lithium composite oxide, and is preferably set to 1˜10 wt % based on the weight of the lithium composite oxide. If the amount thereof is less than 1 wt %, the carbon or organic compound does not exhibit coating effects. In contrast, if the amount thereof exceeds 10 wt %, the carbon or organic compound may hinder intercalation/deintercalation of lithium in the positive electrode active material, undesirably decreasing the capacity of a final lithium secondary battery.

Also, the carbon or organic compound may be applied to a thickness of 3˜25 nm on the surface of the lithium composite oxide. If the coating thickness is less than 3 nm, carbon may be partially applied on the surface, in lieu of forming a uniform coating, and also, surface modification effects which are the purpose of the present invention are not manifested. In contrast, if the coating thickness exceeds 25 nm, a carbon coating layer may directly hinder the intercalation/deintercalation of lithium.

A process of coating the surface of the lithium composite oxide with the carbon or organic compound is not particularly limited so long as it is typically used in the art. For example, there are exemplified a wet coating process in which the carbon or organic compound is dissolved in a solvent (distilled water, an organic solvent, etc.), stirred (using a magnetic bar or with ultrasound) and then applied, a solid coating process such as a ball milling process without the use of a solvent, a gas dispersion process, etc. As such, the coating conditions may be appropriately adjusted depending on the type of carbon or organic compound. The organic solvent may include methanol, ethanol, acetone, etc.

Also, upon coating with the carbon or organic compound, a surfactant may be used so that a carbon source is more efficiently attached to the surface of the lithium composite oxide.

Examples of the surfactant include sodium dodecyl sulfate, cetyltrimethylammonium bromide, dodecyltrimethylammonium bromide, octyltrimethylammonium bromide, etc.

The surfactant may be used in an amount of 10-15 wt % based on the weight of the lithium composite oxide. If the amount thereof is less than 10 wt %, it cannot be uniformly dispersed on the surface. In contrast, if the amount thereof exceeds 15 wt %, the surfactant may be provided in the form of lumps on the surface.

Also, in the case where the material applied on the lithium composite oxide is a conductive polymer, a lithium composite oxide may be added upon preparation of a conductive polymer so that the conductive polymer is grown on the surface of the lithium composite oxide, thus ensuring uniform growth, thereby obtaining surface modification effects of the lithium composite oxide.

In particular, among the conductive polymers, polyaniline may be synthesized by self-stabilized dispersion polymerization. When polyaniline is grown on the surface of the lithium composite oxide by self-stabilized dispersion polymerization, polyaniline is more uniformly grown on the surface of the lithium composite oxide, thereby further improving surface modification effects of the lithium composite oxide. Furthermore, polyaniline is a conductive polymer which is regarded as metallic thanks to an increase in conductivity, thus readily forming a network effective for electron transfer corresponding to the purpose of the present invention.

In the case where polyaniline is synthesized by self-stabilized dispersion polymerization, ammonium peroxydisulfate ((NH₄)₂S₂O₈) is used as a polymerization initiator, and is well dissolved in 1 mol hydrochloric acid (HCl). Thus, in the present invention, an organic solvent and HCl (1 mol) are used at a ratio of 9:1 in order to minimize the effects that an acid has on the positive electrode active material.

As mentioned above, the positive electrode active material for a lithium secondary battery according to the present invention includes the lithium composite oxide, the surface of which is modified using the carbon or organic compound, whereby the carbon or organic compound may act as the site where electrons reside or the path over which electrons travel, thus forming a framework effective for electron transfer. Furthermore, the reaction between Ni⁴⁺ or Co⁴⁺ produced upon charging/discharging which is thermodynamically unstable and HF produced in the electrolyte may be suppressed, so that the lithium secondary battery may be improved in terms of stability and high-rate capability.

In addition, the present invention provides a lithium secondary battery, which comprises a positive electrode having the above positive electrode active material, a negative electrode having a negative electrode active material able to intercalate/deintercalate a lithium ion, an electrolyte disposed therebetween, and optionally a separator.

The lithium secondary battery may be classified into a lithium ion battery, a lithium ion polymer battery and a lithium polymer battery, depending on the kind of separator and electrolyte, and also into a cylindrical shape, a square shape, a coin shape, and a pouch shape depending on the form thereof.

According to an embodiment of the present invention, a lithium secondary battery is manufactured by disposing a negative electrode, a positive electrode, and a separator between the negative electrode and the positive electrode thus forming an electrode assembly, and injecting an electrolyte into the assembly, so that the negative electrode, the positive electrode and the separator are incorporated in the electrolyte.

This positive electrode includes the positive electrode according to the present invention.

The positive electrode may be manufactured by mixing the positive electrode active material, a conductive material, and a binder thus preparing a composition for a positive electrode active material layer, applying the composition on a positive electrode current collector such as aluminum foil, and rolling it.

The binder may include but is not limited to polyvinylalcohol, carboxymethylcellulose, hydroxypropylenecellulose, diacetylenecellulose, polyvinylchloride, polyvinylpyrrolidone, polytetrafluoroethylene, polyvinylidene fluoride, polyethylene or polypropylene.

The conductive material may be used without limitation so long as it is an electrical conductive material usable in a battery, and examples thereof include metal powder or metal fiber, such as natural graphite, artificial graphite, carbon black, acetylene black, Ketjen black, carbon fiber, copper, nickel, aluminum, silver, etc.

The negative electrode includes a negative electrode active material. The negative electrode active material may include a compound that enables the reversible intercalation/deinterclation of lithium. Specific examples of the negative electrode active material include compounds able to adsorb/desorb a lithium ion, including carbonaceous materials, such as artificial graphite, natural graphite, graphitized carbon fiber, amorphous carbon, etc., lithium, lithium alloys, intermetallic compounds, organic compounds, inorganic compounds, metal complexes, and organic polymer compounds. The above compounds may be used alone, or in any combination within a range that does not deteriorate the inventive effects.

More specifically, the carbonaceous material that is used may include any one selected from the group consisting of carbon fiber-based materials, including coke, pyrolysis carbon, natural graphite, artificial graphite, meso-carbon micro beads, graphitized meso-phase spheres, vapor grown carbon, glass carbon and polyacrylonitrile, pitch-based materials, cellulose-based materials, vapor grown carbon-based materials, amorphous carbon, organic material-burned carbon and mixtures thereof, and any combination thereof within a range that does not deteriorate the inventive effects may also be used.

The lithium alloy may include a Li—Al-based alloy, a Li—Al—Mn-based alloy, a Li—Al—Mg-based alloy, a Li—Al—Sn-based alloy, a Li—Al—In-based alloy, a Li—Al—Cd-based alloy, a Li—Al—Te-based alloy, a Li—Ga-based alloy, a Li—Cd-based alloy, a Li—In-based alloy, a Li—Pb-based alloy, a Li—Bi-based alloy and a Li—Mg-based alloy. The alloy and the intermetallic compound may include a compound of transition metal and silicon, a compound of transition metal and tin, etc. Particularly useful is a compound of nickel and silicon.

The negative electrode may also be manufactured by mixing the negative electrode active material, a binder and optionally a conductive material thus preparing a composition for a negative electrode active material layer, which is then applied on a negative electrode current collector such as copper foil.

The electrolyte which is charged in the lithium secondary battery may include a non-aqueous electrolyte or a known solid electrolyte, and may contain a lithium salt dissolved therein.

The lithium salt may be used without limitation so long as it is typically used for a capacitor, and examples thereof include LiClO₄, LiBF₄, LiPF₆, LiAlCl₄, LiSbF₆, LiSCN, LiCF₃SO₃, LiCF₃CO₂, Li (CF₃SO₂)₂, LiAsF₆, LiN(CF₃SO₂)₂, LiB₁₀Cl₁₀, LiBOB (Lithium Bis(oxalate)borate), lithium lower aliphatic carbonate, chloroborane lithium, lithium tetraphenylborate, and imide salts such as LiN(CF₃SO₂)(C₂F₅SO₂), LiN(CF₃SO₂)₂, LiN(C₂F₅SO₂)₂, LiN(CF₃SO₂)(C₄F₉SO₂), etc. The lithium salt may be used alone, or in any combination within a range that does not deteriorate the inventive effects. Particularly useful is LiPF₆.

Furthermore, in order to make the electrolyte nonflammable, carbon tetrachloride, chlorotrifluoroethylene, or a phosphate containing phosphorus may be added to the electrolyte.

In addition to the above electrolyte, any one solid electrolyte selected from the group consisting of an inorganic solid electrolyte, an organic solid electrolyte and mixtures thereof may be used.

The inorganic solid electrolyte may include any one selected from the group consisting of Li₄SiO₄, Li₄SiO₄—LiI—LiOH, Li₃PO₄—Li₄SiO₄, Li₂SiS₃, Li₃PO₄—Li₂S—SiS₂, phosphorus sulfide, and mixtures thereof.

The organic solid electrolyte may include polyethylene oxide, polypropylene oxide, polyvinyl alcohol, polyvinylidene fluoride, fluoropropylene, derivatives thereof, mixtures thereof, or copolymers thereof. The non-aqueous organic solvent functions as a medium able to transfer ions related to the electrochemical reaction of the battery. The non-aqueous organic solvent may include carbonate-, ester-, ether-, or ketone-based solvents.

The carbonate-based solvent may include any one selected from the group consisting of cyclic-carbonate, cyclic carbonic acid ester, and mixtures thereof. The cyclic carbonate may include any one selected from the group consisting of ethylene carbonate (EC), propylene carbonate (PC), butylene carbonate (BC), vinylene carbonate (VC) and mixtures thereof. The cyclic carbonic acid ester may include any one selected from the group consisting of non-cyclic carbonate such as dimethylcarbonate (DMC), diethylcarbonate (DEC), ethylmethylcarbonate (EMC) and dipropylcarbonate (DPC), aliphatic carbonic acid ester, such as methyl formic acid, methyl acetic acid, methyl propionic acid, and ethyl propionic acid, γ-butyrolactone (GBL), and mixtures thereof. Also, aliphatic carbonic acid ester may be used in an amount of not more than 20 vol %, as necessary.

On the other hand, there may be provided a separator between the positive electrode and the negative electrode depending on the kind of the lithium secondary battery. Such a separator may include polyethylene, polypropylene, polyvinylidene fluoride, or a multilayer thereof having two or more layers, and also a mixed multilayer such as a two-layer separator of polyethylene/polypropylene, a three-layer separator of polyethylene/polypropylene/polyethylene, or a three-layer separator of polypropylene/polyethylene/polypropylene may be utilized.

The following examples which are set forth to illustrate but are not to be construed as limiting the present invention, may provide a better understanding of the present invention, and may be appropriately modified or varied by those skilled in the art within the scope of the present invention.

### EXAMPLE

### Example 1

### Surface Treatment of Positive electrode Active Material

0.2 g of cetylalcohol (1 wt % based on LiNi_{0.8}CO_{0.15}Al_{0.05}O₂) was completely dissolved in 20 ml of anhydrous ethanol thus preparing a cetylalcohol solution in a transparent liquid phase, after which 19.8 g of LiNi_{0.8}Co_{0.15}Al_{0.05}O₂ (available from ECOPRO) was added to the cetylalcohol solution and then stirred using a magnetic bar until the solvent was evaporated and a slurry was obtained. As such, in order to aid the evaporation of the solvent, the temperature of a thermal stirrer was maintained at 80-100° C. Subsequently, in order to remove the solvent remaining on the positive electrode active material in a slurry state, drying was performed in an oven at 100° C. for about 10˜24 hours. After complete removal of the solvent, thermal treatment was performed at 600˜700° C. for about 5˜10 hours, thus finally obtaining a surface-modified positive electrode active material.

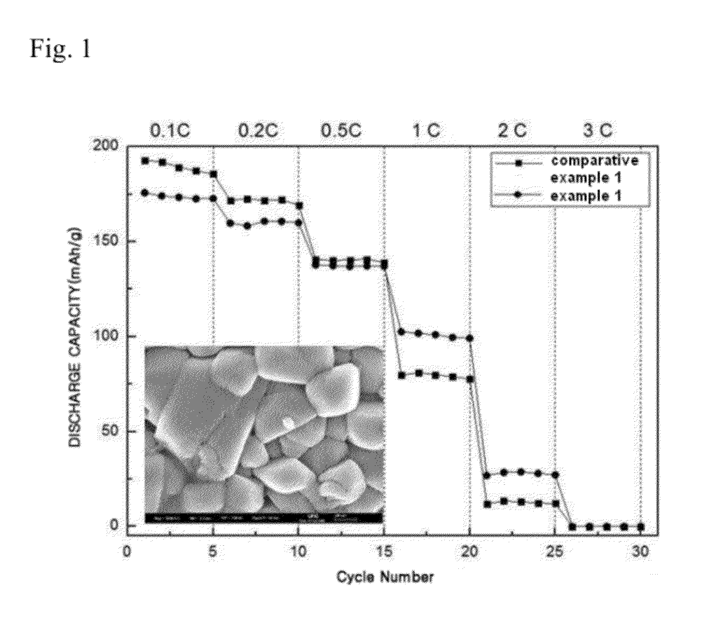

The SEM image of the positive electrode active material thus obtained is shown in FIG. 1.

(Manufacture of Lithium Secondary Battery)

The positive electrode active material thus obtained, Super-P as a conductive material, and polyvinylidene fluoride (PVdF, KF#1300) as a binder were mixed at a weight ratio of 92:4:4, thus preparing a slurry. The slurry was uniformly applied on a piece of aluminum foil 12 μm thick, and dried at 120° C., thus manufacturing a positive electrode.

The positive electrode thus manufactured, lithium foil as a counter electrode, and a porous polyethylene membrane (Celgard 2400) as a separator were subjected to a typical manufacturing process using a liquid electrolyte in which 1 mol LiPF₆ was dissolved in a solvent mixture comprising ethylene carbonate, diethyl carbonate and ethylmethyl carbonate mixed at a volume ratio of 3:3:4, thus manufacturing a coin-shaped battery.

### Example 2

The present example was performed in the same manner as in Example 1, with the exception that upon surface treatment of the positive electrode active material, stirring was carried out using ultrasound, instead of the magnetic bar. As such, in order to prevent the positive electrode active material from sinking during stirring, the solution was continuously stirred using a glass rod.

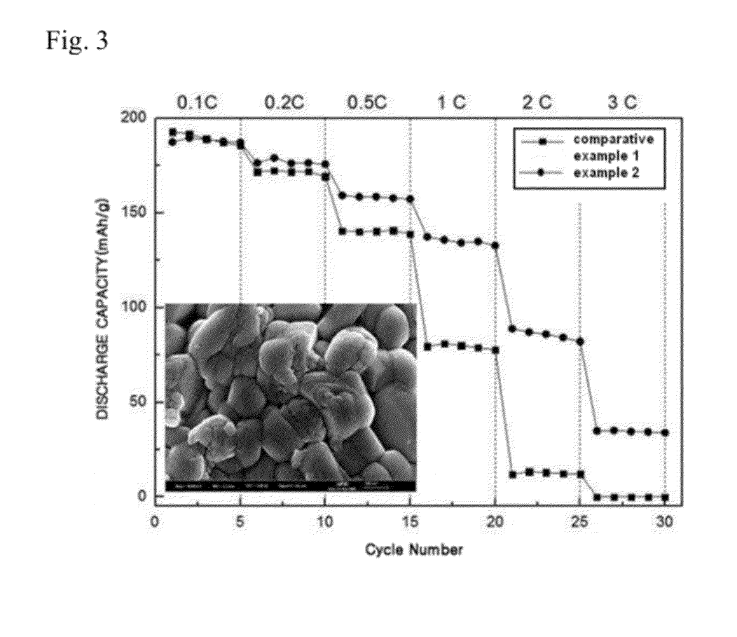

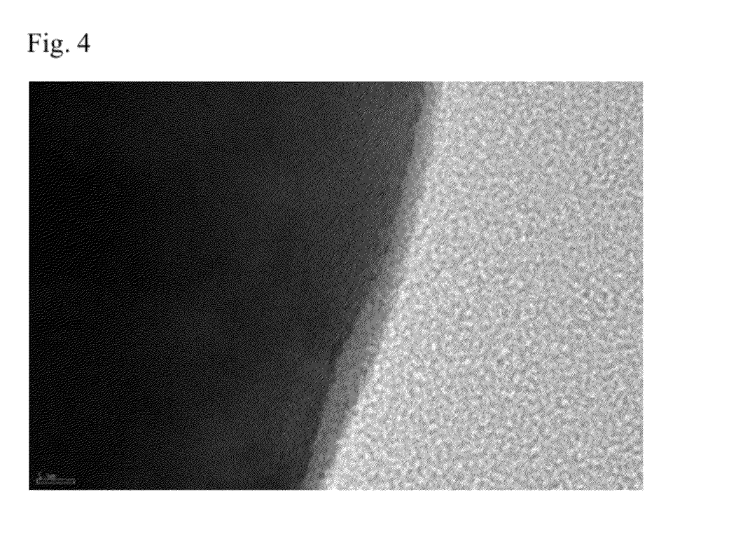

The SEM image of the positive electrode active material thus obtained is shown in FIG. 3, and the TEM image thereof is shown in FIG. 4. As shown in FIG. 4, a carbon coating layer was very uniformly applied to a thickness of 3-5 nm on the surface of LiNi_{0.8}Co_{0.15}Al_{0.05}O₂.

### Example 3

Upon surface treatment of the positive electrode active material in Example 1, the cetylalchol solution was placed in a ball mill together with the positive electrode active material, so that ball milling was conducted. As such, the volume ratio of the ball to the mixture was 3:10˜7:10, and stirring was performed at 350 rpm for 2˜5 hours. Thereafter, the positive electrode active material in a slurry state was treated in the same manner as in Example 1.

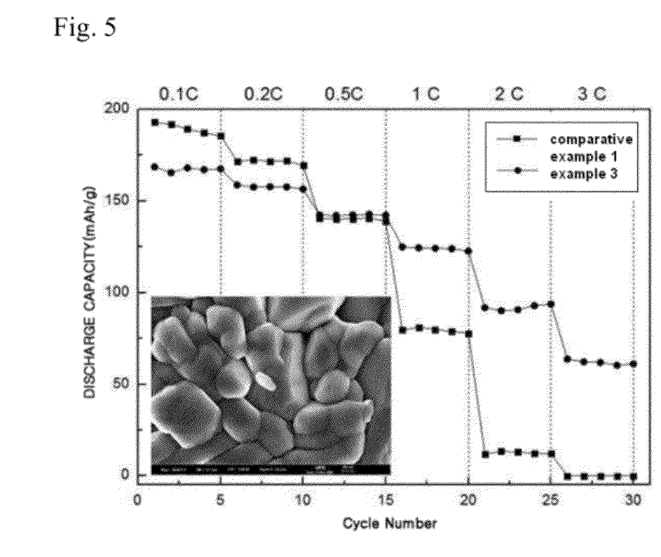

The SEM image of the positive electrode active material thus obtained is shown in FIG. 5.

### Example 4

20 g of LiNi_{0.8}Co_{0.15}Al_{0.05}O₂ (available from ECOPRO) was added to a solution comprising 7 of distilled water and 3 ml of ethanol (the volume ratio of distilled water to ethanol was 7:3), after which 0.03 g of sodium dodecyl sulfate (15 wt % based on sucrose) was added thereto and then dispersed with ultrasound for 10˜20 minutes so that sodium dodecyl sulfate was efficiently dispersed on the surface of LiNi_{0.8}Co_{0.15}Al_{0.05}O₂. Subsequently, 0.02 g of sucrose (1 wt % based on LiNi_{0.8}Co_{0.15}Al_{0.05}O₂) was added to the solution dispersed with ultrasound for 10˜20 minutes, and while the solution was continuously stirred with a glass rod to prevent the LiNi_{0.8}Co_{0.15}Al_{0.05}O₂ from sinking, the solution was further dispersed with ultrasound for 30 minutes. Subsequently, the positive electrode active material in a slurry state was dried in a vacuum oven at 80° C. for about 8˜10 hours to remove the solvent therefrom. After complete removal of the solvent, thermal treatment was conducted at 600˜700° C. for abut 5˜10 hours, thus finally manufacturing a surface-modified positive electrode active material.

(Manufacture of Lithium Secondary Battery)

A lithium secondary battery was manufactured in the same manner as in Example 1.

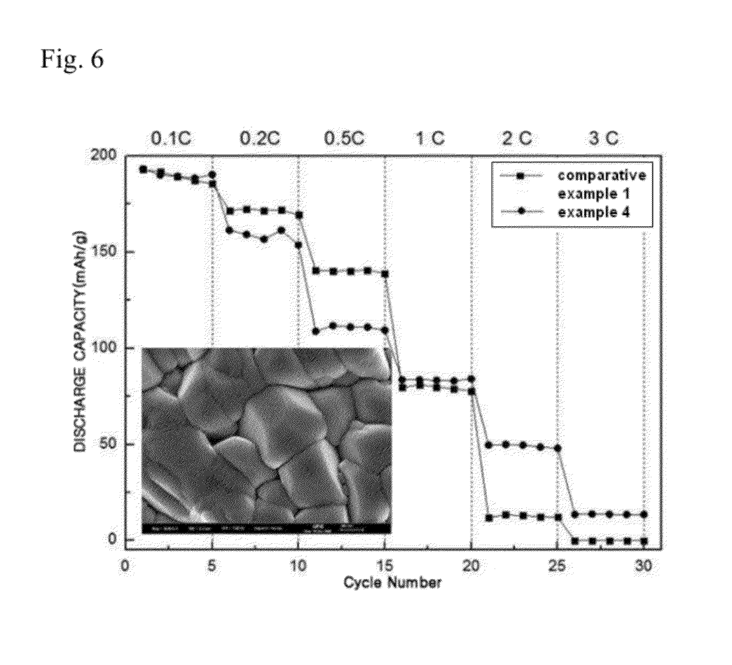

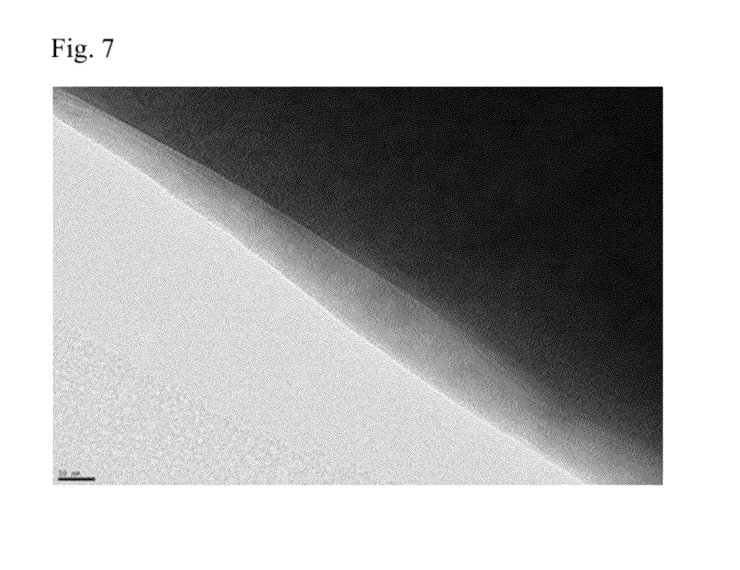

The SEM image of the positive electrode active material thus obtained is shown in FIG. 6. Also, the TEM image thereof is shown in FIG. 7. As shown in FIG. 7, a carbon coating layer was very uniformly applied to a thickness of 10˜17 nm on the surface of LiNi_{0.8}Co_{0.15}Al_{0.05}O₂.

### Example 5

20 g of LiNi_{0.8}Co_{0.15}Al_{0.05}O₂ (available from ECOPRO) was added to a solution comprising 5 ml of ethanol and 15 ml of water (the volume ratio of ethanol to water was 3:1) and then dispersed with ultrasound, after which 1.0 (0.98 ml) g of aniline was slowly added in droplets thereto and uniformly dispersed with ultrasound. As such, the total time was set to about 20˜30 minutes. To the above solution at 0˜5° C., a solution of 0.57 g (25 mol % based on aniline) of ammonium peroxydisulfate ((NH₄)₂S₂O₀ dissolved in 1 mol HCl comprising 1 ml of 37 wt % HCl and 9 ml of distilled water mixed together was added in droplets with stirring using a stirrer. The introduction and stirring time of ammonium peroxydisulfate was 10˜15 hours. After completion of the stirring, ethanol was allowed to flow while performing vacuum filtration, thus removing byproducts and washing the positive electrode active material. Subsequently, while acetone was allowed to flow, a low-molecular-weight oligomer and other organic materials were removed. After completion of the filtration, drying was performed in a vacuum oven at 50˜60° C. for 10˜24 hours. Thereafter, the positive electrode active material coated with polyaniline was added to an acetone solvent and doped with camphor sulfonic acid (HCSA). As such, the molar ratio of HCSA to the produced polyaniline was 10:1˜10:0.5. After completion of the doping, drying was conducted in a vacuum oven at 50˜60° C. for 10˜24 hours, thus producing a positive electrode active material surface-modified with polyaniline.

(Manufacture of Lithium Secondary Battery)

A lithium secondary battery was manufactured in the same manner as in Example 1.

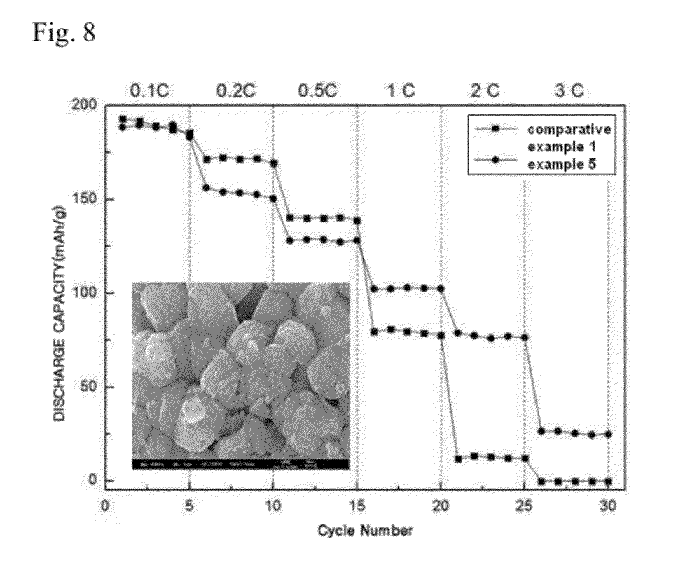

The SEM image of the positive electrode active material thus obtained is shown in FIG. 8. As shown in FIG. 8, the positive electrode active material particles were covered with polyaniline in network form on the surface of LiNi_{0.8}Co_{0.15}Al_{0.05}O₂.

### Comparative Example 1

A lithium secondary battery was manufactured in the same manner as in Example 1 using LiNi_{0.8}Co_{0.15}Al_{0.05}O₂ (available from ECOPRO) which was not surface-treated.

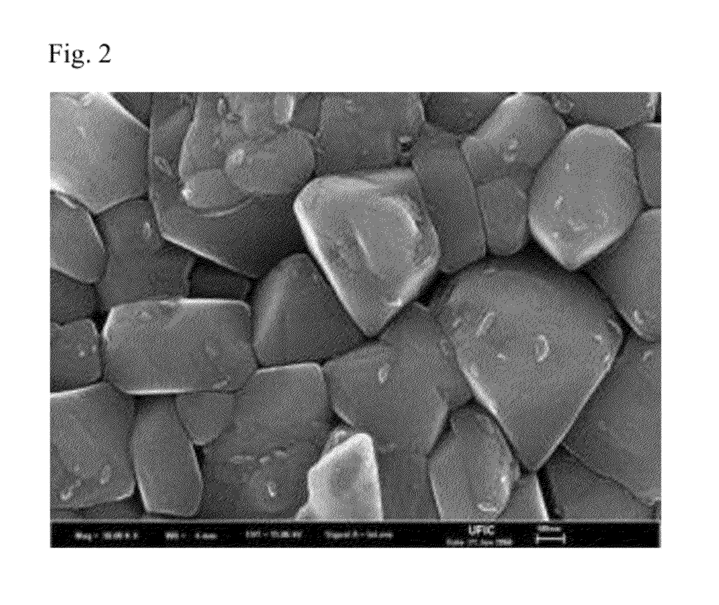

The SEM image of Comparative Example 1 is shown in FIG. 2.

Test Example: Discharge Properties in relation to Current Density

### Test Example 1-1

In order to compare the discharge properties in relation to the current density of the lithium secondary battery of Example 1 and the lithium secondary battery of Comparative Example 1, charge/discharge tests were respectively performed for 5 cycles under current density conditions of a temperature of 25° C., a potential of 2.8-4.3 V, and a discharge current of 0.1, 0.2, 0.5, 1, 2, 3C (1C=180 mAh/g) using a charge/discharge cycler. The results are shown in FIG. 1. As shown in FIG. 1, in the case of the lithium secondary battery of Example 1 including the positive electrode active material surface-modified with carbon according to the present invention, the discharge properties were similar in the range of 0.1˜1C but were improved from 1C, compared to Comparative Example 1 using the positive electrode active material which was not surface-treated.

### Test Example 1-2

The discharge properties of the lithium secondary battery of Example 2 in relation to the current density were measured in the same manner as in Test Example 1-1. The results are shown in FIG. 3. As shown in FIG. 3, in the case of the lithium secondary battery of Example 2 including the positive electrode active material surface-modified with carbon according to the present invention, the discharge properties were remarkably improved from 0.5C, compared to Comparative Example 1 using the positive electrode active material which was not surface-treated.

### Test Example 1-3

The discharge properties of the lithium secondary battery of Example 3 in relation to the current density were measured in the same manner as in Test Example 1-1. The results are shown in FIG. 5. As shown in FIG. 5, in the case of the lithium secondary battery of Example 3 including the positive electrode active material surface-modified with carbon according to the present invention, the discharge properties were similar in the range of 0.1˜1C but were improved from 1C, compared to Comparative Example 1 using the positive electrode active material which was not surface-treated.

### Test Example 1-4

The discharge properties of the lithium secondary battery of Example 4 in relation to the current density were measured in the same manner as in Test Example 1-1. The results are shown in FIG. 6. As shown in FIG. 6, in the case of the lithium secondary battery of Example 4 including the positive electrode active material surface-modified with carbon according to the present invention, the discharge properties were remarkably improved from 2C, compared to Comparative Example 1 using the positive electrode active material which was not surface-treated.

### Test Example 1-5

The discharge properties of the lithium secondary battery of Example 5 in relation to the current density were measured in the same manner as in Test Example 1-1. The results are shown in FIG. 6. As shown in FIG. 6, in the case of the lithium secondary battery of Example 5 including the positive electrode active material surface-modified with carbon according to the present invention, the discharge properties were similar in the range of 0.1-1C but were improved from 1C, compared to Comparative Example 1 using the positive electrode active material which was not surface-treated.

Although the preferred embodiments of the present invention have been disclosed for illustrative purposes, those skilled in the art will appreciate that various modifications or variations are possible, without departing from the scope and spirit of the invention. Also, the accompanying claims include such modifications or variations within the scope of the present invention.

1. A positive electrode active material for a lithium secondary battery, comprising a lithium composite oxide represented by Chemical Formula 1 below which is surface-modified using carbon or an organic compound.
LiNi₁₋ₓMₓO₂ <Chemical Formula 1>
(wherein M represents any one or a combination of two elements selected from the group consisting of Co, Al, Mn, Mg, Fe, Cu, Ti, Sn and Cr, and 0.96≦x≦1.05)

2. The positive electrode active material of claim 1, wherein the lithium composite oxide is a lithium composite oxide represented by Chemical Formula 2 below.
Liₓ[Ni_{1-y-z}CO_{y}Al_{z}]O₂ <Chemical Formula 2>
(wherein 0.96≦x≦1.05, 0≦y≦0.2, 0≦z≦0.1)

3. The positive electrode active material of claim 1, wherein the carbon or organic compound is any one or more selected from the group consisting of carbon, solid alcohol, saccharides, citric acid, and a conductive polymer.

4. The positive electrode active material of claim 3, wherein the conductive polymer is any one or more selected from the group consisting of polyaniline, polypyrrole, polythiophene and derivative monomers thereof.

5. The positive electrode active material of claim 1, wherein the carbon or organic compound is used in an amount of 1˜10 wt % based on weight of the lithium composite oxide.

6. The positive electrode active material of claim 1, wherein the carbon or organic compound is applied to a thickness of 3˜25 nm on a surface of the lithium composite oxide.

7. The positive electrode active material of claim 1, wherein the carbon or organic compound is applied on the surface of the lithium composite oxide using any one selected from the group consisting of a wet coating process that performs coating with a solution of the carbon or organic compound dissolved in a solvent, a solid phase process, and a gas dispersion process.

8. The positive electrode active material of claim 7, wherein the wet coating process is performed using ultrasound.

9. The positive electrode active material of claim 4, wherein the polyaniline is synthesized by self-stabilized dispersion polymerization.

10. The positive electrode active material of claim 1, wherein a surfactant is further added upon surface modification using the carbon or organic compound.

11. The positive electrode active material of claim 10, wherein the surfactant is any one or more selected from the group consisting of sodium dodecyl sulfate, cetyltrimethylammonium bromide, dodecyltrimethylammonium bromide, and octyltrimethylammonium bromide.

12. A lithium secondary battery using a positive electrode comprising the positive electrode active material of claim 1.
